(19) United States
(12) Patent Application Publication
(10) Pub. No.: US 2017/0206258 A1
(43) Pub. Date: Jul. 20, 2017

(54) METHOD FOR VISUALIZING TOPIC EVOLUTION BASED ON TIME AND GEOGRAPHY

(71) Applicant: International Business Machines Corporation, Armonk, NY (US)

(72) Inventors: Mansi Awasthi, Bhopal (IN); Krishna Kummamuru, Bangalore (IN)

(21) Appl. No.: 15/000,076

(22) Filed: Jan. 19, 2016

(51) Int. Cl. G06F 17/30

(52) U.S. Cl. CPC G06F 17/30572; G06F 17/30241; G06F 17/3087; G06F 17/30867; G06F 17/30554

(57) ABSTRACT

In an approach to spatio-temporal visualization of the evolution of a topic, a computing device receives textual data from one or more sources. The computing device determines, based on semantic analysis, one or more topics of interest associated with the textual data, the location criteria, and the time criteria, wherein semantic analysis comprises merging related topics and splitting unrelated topics. The computing device generates one or more user-navigable visualizations comprising one or more graphs representing occurrences of a topic of interest in a designated geographic area and spanning a designated time window. The computing device displays the one or more user-navigable visualizations and one or more selector tools for designating a geographic area and a time window.

### TECHNICAL FIELD OF THE INVENTION

The present disclosure relates generally to the field of exploratory data analysis, and more particularly to generation of topic visualizations based on semantic analysis.

### BACKGROUND OF THE INVENTION

What constitutes a “topic of interest” varies depending on the location and time in question. For example, the J&K Floods of 2014 were an important topic in India that year, but they may have had little or no following in China at the same time. Topic visualizations can assist with the difficult task of assessing the popularity of a topic at a particular spatio-temporal juncture and tracking the variations in and evolution of topic prevalence based on location and time. Semantic analysis, comprising machine learning techniques for deriving concepts from a large collection of information, can further assist in defining the topic of interest.

### SUMMARY

According to one embodiment of the present invention, a computer-implemented method for spatio-temporal topic visualization is provided. The method comprises: receiving, by one or more computer processors, textual data from one or more sources; filtering, by one or more computer processors, the textual data based on location criteria and time criteria; determining, by one or more computer processors, based on semantic analysis, one or more topics of interest associated with the textual data, the location criteria, and the time criteria, wherein semantic analysis comprises merging related topics and splitting unrelated topics; generating, by one or more computer processors, one or more user-navigable visualizations, wherein the one or more user-navigable visualizations comprise one or more graphs representing occurrences of a topic of interest in a designated geographic area and spanning a designated time window; displaying, by one or more computer processors, the one or more user-navigable visualizations; and displaying, by one or more computer processors, one or more selector tools for designating a geographic area and a time window.

According to another embodiment of the present invention, a computer program product for spatio-temporal topic visualization is provided, the computer program product comprising one or more computer readable storage media and program instructions stored on the one or more computer readable storage media, the program instructions comprising: program instructions to receive textual data from one or more sources; program instructions to filter the textual data based on location criteria and time criteria; program instructions to determine, based on semantic analysis, one or more topics of interest associated with the textual data, the location criteria, and the time criteria, wherein semantic analysis comprises merging related topics and splitting unrelated topics; program instructions to generate one or more user-navigable visualizations, wherein the one or more user-navigable visualizations comprise one or more graphs representing occurrences of a topic of interest in a designated geographic area and spanning a designated time window; program instructions to display the one or more user-navigable visualizations; and program instructions to display one or more selector tools for designating a geographic area and a time window.

According to another embodiment of the present invention, a computer system for spatio-temporal topic visualization is provided, the computer system comprising one or more user interfaces; one or more processors; one or more computer readable storage media; and program instructions stored on the one or more computer readable storage media for execution by at least one of the one or more processors, the program instructions comprising: program instructions to receive textual data from one or more sources; program instructions to filter the textual data based on location criteria and time criteria; program instructions to determine, based on semantic analysis, one or more topics of interest associated with the textual data, the location criteria, and the time criteria, wherein semantic analysis comprises merging related topics and splitting unrelated topics; program instructions to generate one or more user-navigable visualizations, wherein the one or more user-navigable visualizations comprise one or more graphs representing occurrences of a topic of interest in a designated geographic area and spanning a designated time window; program instructions to display the one or more user-navigable visualizations; and program instructions to display one or more selector tools for designating a geographic area and a time window.

### BRIEF DESCRIPTION OF THE DRAWINGS

FIG. 1 is a functional block diagram of an exemplary computing environment, in accordance with an embodiment of the present invention;

FIG. 2 is a flowchart depicting steps of a spatio-temporal topic visualization method, in accordance with an embodiment of the present invention;

FIG. 3A-B shows exemplary spatio-temporal topic visualizations as displayed via a user interface, in accordance with an embodiment of the present invention; and

FIG. 4 is a block diagram of components of the computing device in FIG. 1 executing a spatio-temporal topic visualization program, in accordance with an embodiment of the present invention.

### DETAILED DESCRIPTION

Exploratory data analysis has allowed for new insights due to the visualization of traffic patterns, association of content consumption or social media communications with a geographic area, and real-time discovery of socio-cultural information (e.g., societal mood, languages spoken) for a geographic area. Embodiments described herein create further possibilities by generating navigable visualizations that show the evolution of a topic within a designated geographic area and time window, and offer additional benefits such as, but not limited to, working across many types of datasets, rather than being limited to working with a particular, predefined dataset; allowing a user to designate and adjust a desired time window; and allowing the user to merge and split concepts to define a topic of interest with greater specificity.

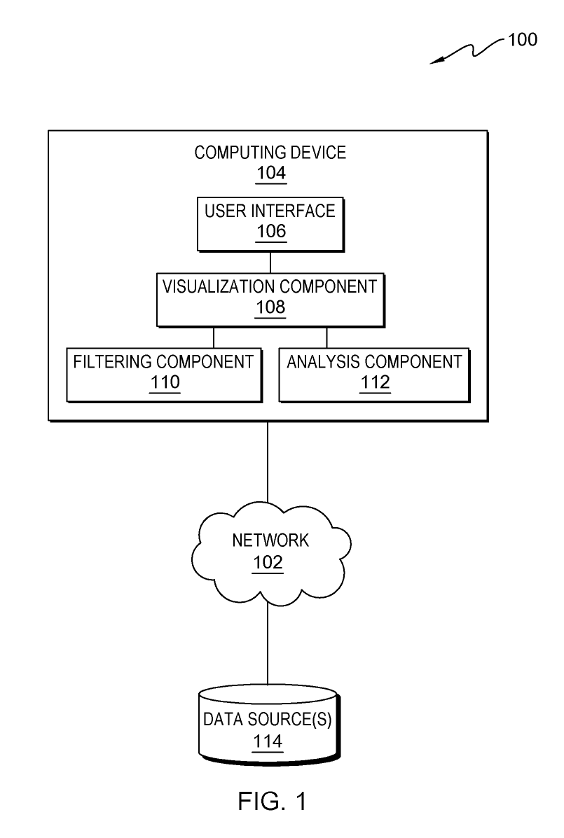

Embodiments of the present invention are described herein with reference to the Figures. FIG. 1 shows a block diagram of a computing environment 100, in accordance with an embodiment of the present invention. FIG. 1 is provided for the purposes of illustration and does not imply any limitations with regard to the environments in which different embodiments can be implemented. Many modifications to the depicted environment can be made by those skilled in the art without departing from the scope of the invention as recited in the claims.

Computing environment 100 includes computing device 104, which can be interconnected with other devices (not shown) over network 102. Network 102 can be, for example, a telecommunications network, a local area network (LAN), a wide area network (WAN), such as the Internet, or a combination of these, and can include wired, wireless, or fiber optic connections. In general, network 102 can be any combination of connections and protocols that will support communications between computing device 104 and other computing devices (not shown) within computing environment 100.

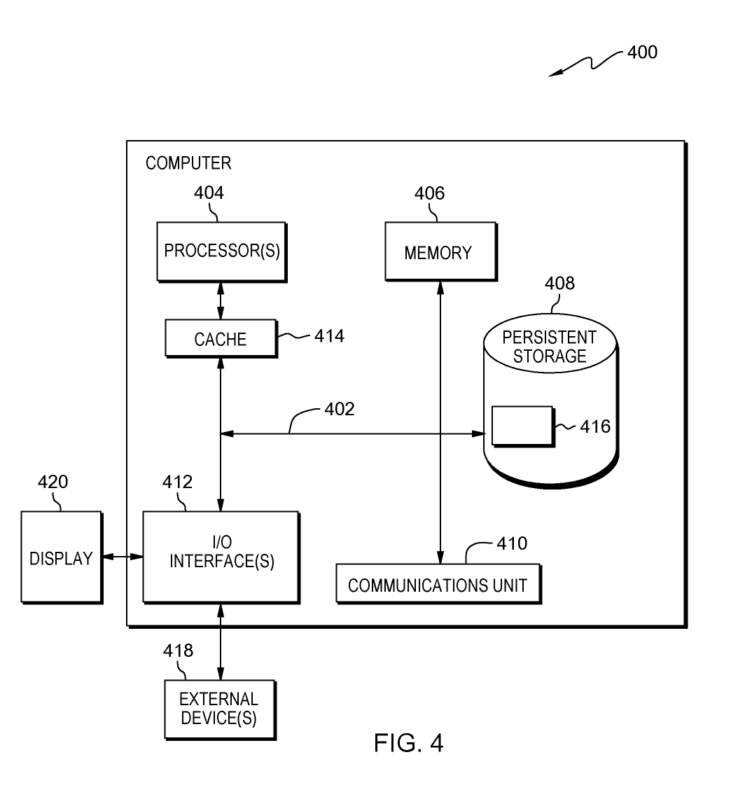

Computing device 104 can be any programmable electronic device capable of executing machine-readable instructions, communicating with other devices over network 102, and presenting information to a user via a user interface. Computing device 104 includes user interface 106, visualization component 108, filtering component 110, and analysis component 112. Computing device 104 can include internal and external hardware components, as depicted and described in further detail with reference to FIG. 4.

User interface 106 provides an interface between a user of computing device 104 and computing device 104. User interface 106 can be, but is not limited to being, a graphical user interface (GUI) or a web user interface (WUI) and can display text, documents, web browser windows, user options, application interfaces, and instructions for operation, and can include the information (such as graphic, text, and sound) presented to a user and the control sequences the user employs to control visualization component 108.

Visualization component 108 generates one or more visualizations of incoming data (i.e., from data source(s) 114, described herein), also referred to herein as “data,” to be displayed via user interface 106, wherein the visualization(s) can be navigated (interacted with) by a user in order to designate, e.g., a specific geographic area or a specific time window. In an exemplary embodiment, visualization component 108 causes the following display elements to be displayed via user interface 106:

(1) A window showing a geographic area for analysis;

(2) A geographic area selector tool;

(3) A graph showing occurrences of a topic over time;

(4) A time window selector tool; and

(5) A selector tool for merging and splitting concepts.

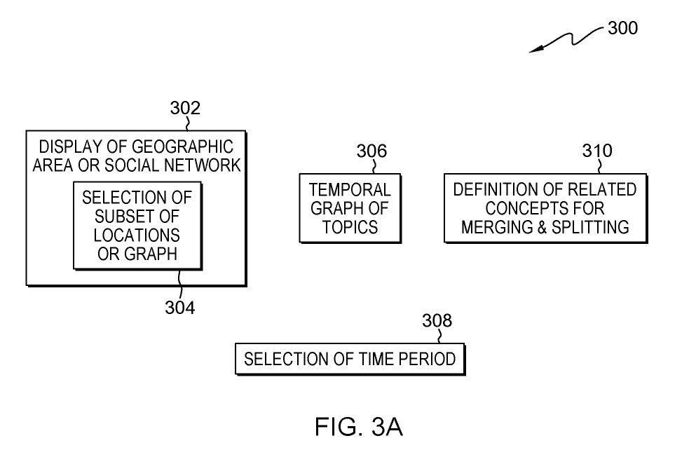

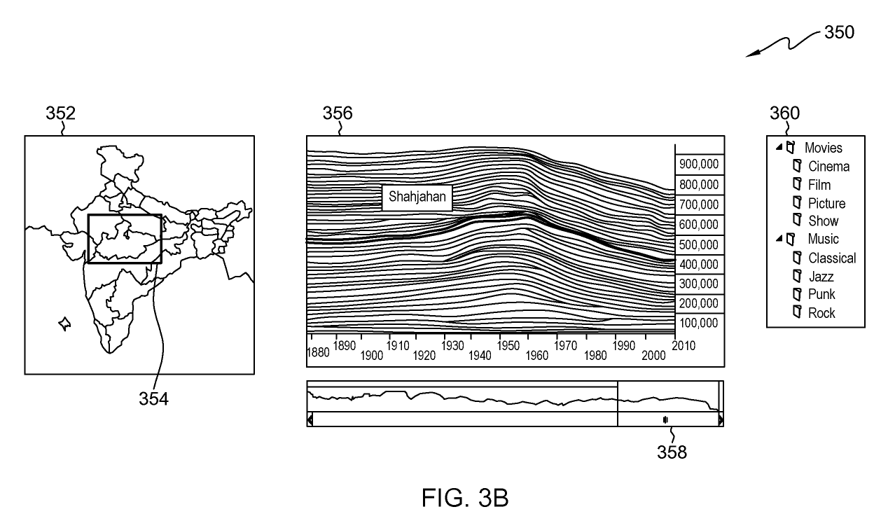

Exemplary display elements are detailed herein with reference to FIG. 3A-B.

Filtering component 110 filters incoming data based on predefined criteria, which can include but are not limited to including location, time, and one or more other special constraints. Location is, for example but without limitation, a geographic area within a defined number of square miles, or a particular social network. Time is, for example but without limitation, a time window beginning and ending at defined dates and times. A special constraint can include, for example but without limitation, a designated topic area (e.g., sports-related topics, technology-related topics, political topics).

The criteria that filtering component 110 uses to filter incoming data are adjusted as a user navigates a visualization, as described in further detail with respect to FIG. 3B. For example, if a user makes a selection changing the geographic area represented in the visualization, filtering component 110 filters incoming data to include data corresponding to the newly selected geographic area. For example, if the user makes a selection changing his or her focus from New Delhi to Boston, filtering component 110 no longer selects data originating in New Delhi for representation in the visualization, and instead selects data originating in Boston for representation in the visualization.

Analysis component 112 can work online or offline to process incoming data, in order to determine one or more topics of interest (also referred to herein as “topics” or “concepts”) to be represented in the visualization(s) generated by visualization component 108. Analysis component 112 performs semantic analysis on the filtered data in order to determine one or more topics of interest associated with the selected geographic area, time window, and any other designated constraint(s). Semantic analysis can include, for example, merging and splitting concepts in order to recognize that occurrences of different words can refer to the same concept, or that occurrences of the same word can refer to different concepts. For example, the concepts indicated by occurrences of the words “401(k)” and “pension plan” can be merged, and the different occurrences of the word “domino,” wherein one occurrence refers to pizza and the other occurrence refers to a game, can be split.

Data source(s) 114 is comprised of one or more sources of incoming data. Data source(s) 114 can include, but is not limited to including, social networks and newsfeeds.

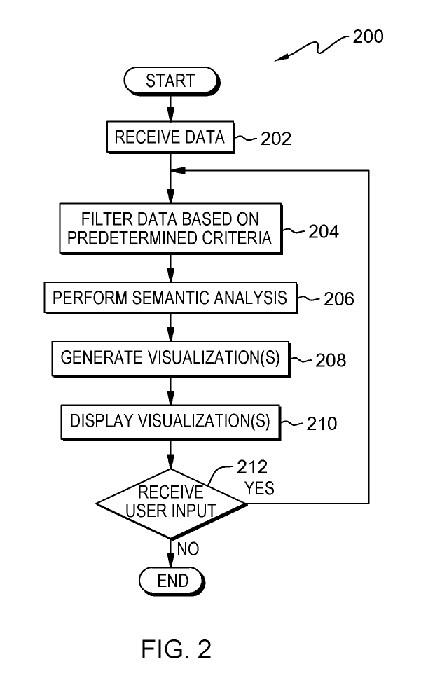

FIG. 2 is a flowchart 200 depicting operational steps of a spatio-temporal topic visualization method, in accordance with an embodiment of the present invention.

In step 202, visualization component 108 receives data, which may include but is not limited to including social media communications (e.g., tweets), news headlines, and corporate documents such as financial reports received from data source(s) 114.

In step 204, filtering component 110 filters the data based on predefined criteria, such as but not limited to location, time, and one or more topic-related constraints (e.g., sports-related topics, technology-related topics, or political topics in the case of social media and newsfeed data; or a particular business area in the case of corporate documents such as financial reports). For example, filtering component 110 determines based on the location and time information associated with a tweet that the tweet meets the necessary criteria for representation in one or more visualizations. In another example, filtering component 110 determines based on the address of the corporate headquarters indicated on a financial report that the financial report meets the necessary criteria for representation in one or more visualizations.

In step 206, analysis component 112 performs semantic analysis on the filtered data to identify one or more topic(s) for visualization. For example, analysis component 112 determines that occurrences of the words “401(k)” and “pension plan” can be merged into a single topic, and that occurrences of the word “domino” can be split into a topic related to pizza and a topic related to table games.

In step 208, visualization component 108 generates one or more visualizations of the filtered data. For example, visualization component 108 generates a graph showing occurrences of a concept (e.g., with occurrences represented on the y-axis, in hundreds of thousands) in the filtered data at a given time (e.g., with time represented on the x-axis, by decade).

In step 210, visualization component 108 displays the one or more visualizations via user interface 106.

In optional step 212, a user can choose to navigate the visualization(s) via user interface 106. If, for example, the user uses a displayed selection tool to change a filtering criterion, filtering component 110 repeats step 204 based on the new criterion, selecting a new set of filtered data, and analysis component 112 repeats step 206 and visualization component 108 repeats steps 208-210 based on the newly filtered data.

FIG. 3A-B shows examples of spatio-temporal topic visualizations as displayed via user interface 106, in accordance with an embodiment of the present invention. Variation in the appearance and arrangement of the visualizations is possible such that, for example but without limitation, fewer than all of the display elements shown in FIG. 3A-B are displayed.

FIG. 3A shows diagram 300 of an exemplary arrangement of spatio-temporal topic visualizations displayed via user interface 106, in accordance with an embodiment of the present invention. Display element 302 represents the scope of the data analyzed by analysis component 112 (i.e., the scope of the data selected by filtering component 110) in terms of, for example but without limitation, the geographic area from which the data originates or the social network from which the data originates. Display element 304 is a selector tool that a user can control (e.g., move and/or adjust) in order to change the scope of the data analyzed. For example, if display element 302 is a world map, display element 304 can be a window that the user navigates to different regions of the map in order to select a geographic area, and thus change the geographic constraint based on which filtering component 110 filters incoming data.

Display element 306 represents occurrences of a topic in a designated time window. Display element 308 is a selection tool that a user can control in order to designate the starting and ending points of the time window represented in display element 306.

Display element 310 is a window comprising a selector tool for merging and splitting concepts. A user can, for example, select one or more general contexts or sub-contexts, as illustrated herein with reference to FIG. 3B, to be represented by display element 306.

FIG. 3B shows diagram 350 of exemplary displayed spatio-temporal topic visualizations, in accordance with an embodiment of the present invention. For example, FIG. 3B shows a visualization of the popularity of topics related to the name “Shajahan” over time. Display element 352 represents the geographic scope of the data analyzed by analysis component 112. In this example, display element 352 is a map of different states in India.

Display element 354 is a selection tool that a user can control in order to change the geographic scope of the data analyzed. In this example, display element 354 is a window that the user can move across display element 352 in order to select, e.g., a particular state. In this example, because display element 354 is centered on the state of Madhya Pradesh and areas bordering that state, filtering component 110 will select incoming data originating from Madhya Pradesh and the designated bordering areas for analysis by analysis component 112.

Display element 356 is a graph showing occurrences of the name “Shahjahan” in a designated time window. Display element 356 shows time, in decades, on the x-axis and occurrences of “Shahjahan,” in hundreds of thousands, on the y-axis. An occurrence can be, for example, a mention in a social media post or a news headline. Display element 356 can employ other visual cues to assist a user in interpreting the visualized data. For example, bands in display element 356 can be color-coded in order to assist the user in differentiating between different contexts represented in the same visualization (e.g., occurrences of “Shahjahan” in Movies can appear in shades of red, occurrences of “Shahjahan” in Music can appear in shades of blue).

Display element 358 is a selector tool that the user can control in order to designate a different time window for representation in display element 356.

Display element 360 is a selector tool that the user can control in order to merge and split concepts. In this example, occurrences of “Shahjahan” can appear in the context of movies and in the context of music, and in various sub-contexts within the respective contexts of movies and music. The user can control display element 360 in order to select, e.g., multiple contexts or a single sub-context. Responsive to the user selection, display element 356, e.g., represents occurrences of “Shahjahan” in multiple contexts (e.g., Movies) or occurrences of “Shahjahan” in a single sub-context (e.g., Cinema), respectively.

FIG. 4 depicts a block diagram 400 of components of computing device 104 in computing environment 100, in accordance with illustrative embodiments of the present invention. It should be appreciated that FIG. 4 provides only an illustration of one implementation and does not imply any limitations with regard to the environments in which different embodiments may be implemented. Many modifications to the depicted environment may be made.

Computing device 104 includes communications fabric 402, which provides communications between computer processor(s) 404, memory 406, persistent storage 408, communications unit 410, and input/output (I/O) interface(s) 412, and cache 414. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer readable storage media. In this embodiment, memory 406 includes random access memory (RAM) and cache memory 414. In general, memory 406 can include any suitable volatile or non-volatile computer readable storage media. Cache 414 is a fast memory that enhances the performance of computer processor(s) 404 by holding recently accessed data, and data near accessed data, from memory 406.

Program instructions and data used to practice embodiments of the invention, referred to collectively as component(s) 416, are stored in persistent storage 408 for execution and/or access by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 408 may also be removable. For example, a removable hard drive can be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices. Communications unit 410 can include one or more network interface cards. Communications unit 410 can provide communications through the use of either or both physical and wireless communications links. Component(s) 416 can be downloaded to persistent storage 408 through communications unit 410.

I/O interface(s) 412 allows for input and output of data with other devices that may be connected to computing device 104. For example, I/O interface 412 can provide a connection to external devices 418 such as a keyboard, keypad, a touch screen, and/or some other suitable input device. External devices 418 can also include portable computer readable storage media such as, for example, thumb drives, portable optical or magnetic disks, and memory cards. Software and data used to practice embodiments of the present invention, e.g., component(s) 416, can be stored on such portable computer readable storage media and can be loaded onto persistent storage 408 via I/O interface(s) 412. I/O interface(s) 412 also connect to a display 420.

Display 420 provides a mechanism to display data to a user and may be, for example, a touchscreen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method for spatio-temporal topic visualization, the method comprising:
receiving, by one or more computer processors, textual data from one or more sources;
filtering, by one or more computer processors, the textual data based on location criteria and time criteria;
determining, by one or more computer processors, based on semantic analysis, one or more topics of interest associated with the textual data, the location criteria, and the time criteria, wherein semantic analysis comprises merging related topics and splitting unrelated topics;
generating, by one or more computer processors, one or more user-navigable visualizations, wherein the one or more user-navigable visualizations comprise one or more graphs representing occurrences of a topic of interest in a designated geographic area and spanning a designated time window;
displaying, by one or more computer processors, the one or more user-navigable visualizations; and
displaying, by one or more computer processors, one or more selector tools for designating a geographic area and a time window.

2. The computer-implemented method of claim 1, wherein textual data comprises one or more of social media data, news headlines, and financial reports.

3. The computer-implemented method of claim 1, further comprising:
filtering, by one or more computer processors, the textual data based on topic area.

4. The computer-implemented method of claim 1, wherein the one or more selector tools further comprise a selector tool for user-designated merging and splitting of topics.

5. The computer-implemented method of claim 1, further comprising:
receiving, by one or more computer processors, a user input controlling a selector tool to alter one or more of the location criteria and time criteria;
filtering, by one or more computer processors, the textual data based on the altered criteria;
determining, by one or more computer processors, based on semantic analysis, one or more topics of interest associated with the textual data filtered based on the altered criteria;
generating, by one or more computer processors, one or more altered user-navigable visualizations; and
displaying, by one or more computer processors, the one or more altered user-navigable visualizations.

6. The computer-implemented method of claim 1, further comprising:
receiving, by one or more computer processors, a user input controlling a selector tool to merge one or more topics;
generating, by one or more computer processors, one or more altered user-navigable visualizations based on the user input; and
displaying, by one or more computer processors, the one or more altered user-navigable visualizations.

7. The computer-implemented method of claim 1, further comprising:
receiving, by one or more computer processors, a user input controlling a selector tool to split one or more topics;
generating, by one or more computer processors, one or more altered user-navigable visualizations based on the user input; and
displaying, by one or more computer processors, the one or more altered user-navigable visualizations.

8. A computer program product for spatio-temporal topic visualization, the computer program product comprising:
one or more computer readable storage media and program instructions stored on the one or more computer readable storage media, the program instructions comprising:
program instructions to receive textual data from one or more sources;
program instructions to filter the textual data based on location criteria and time criteria;
program instructions to determine, based on semantic analysis, one or more topics of interest associated with the textual data, the location criteria, and the time criteria, wherein semantic analysis comprises merging related topics and splitting unrelated topics;
program instructions to generate one or more user-navigable visualizations, wherein the one or more user-navigable visualizations comprise one or more graphs representing occurrences of a topic of interest in a designated geographic area and spanning a designated time window;
program instructions to display the one or more user-navigable visualizations; and
program instructions to display one or more selector tools for designating a geographic area and a time window.

9. The computer program product of claim 8, wherein textual data comprises one or more of social media data, news headlines, and financial reports.

10. The computer program product of claim 8, further comprising:
program instructions to filter the textual data based on topic area.

11. The computer program product of claim 8, wherein the one or more selector tools further comprise a selector tool for user-designated merging and splitting of topics.

12. The computer program product of claim 8, further comprising:
program instructions to receive a user input controlling a selector tool to alter one or more of the location criteria and time criteria;
program instructions to filter the textual data based on the altered criteria;
program instructions to determine, based on semantic analysis, one or more topics of interest associated with the textual data filtered based on the altered criteria;
program instructions to generate one or more altered user-navigable visualizations; and
program instructions to display the one or more altered user-navigable visualizations.

13. The computer program product of claim 8, further comprising:
program instructions to receive a user input controlling a selector tool to merge one or more topics;
program instructions to generate one or more altered user-navigable visualizations based on the user input; and
program instructions to display the one or more altered user-navigable visualizations.

14. The computer program product of claim 8, further comprising:
program instructions to receive a user input controlling a selector tool to split one or more topics;
program instructions to generate one or more altered user-navigable visualizations based on the user input; and
program instructions to display the one or more altered user-navigable visualizations.

15. A computer system for spatio-temporal topic visualization, the computer system comprising:
one or more user interfaces;
one or more processors;
one or more computer readable storage media; and
program instructions stored on the one or more computer readable storage media for execution by at least one of the one or more processors, the program instructions comprising: program instructions to receive textual data from one or more sources;
program instructions to filter the textual data based on location criteria and time criteria;
program instructions to determine, based on semantic analysis, one or more topics of interest associated with the textual data, the location criteria, and the time criteria, wherein semantic analysis comprises merging related topics and splitting unrelated topics;
program instructions to generate one or more user-navigable visualizations, wherein the one or more user-navigable visualizations comprise one or more graphs representing occurrences of a topic of interest in a designated geographic area and spanning a designated time window;
program instructions to display the one or more user-navigable visualizations; and
program instructions to display one or more selector tools for designating a geographic area and a time window.

16. The computer system of claim 15, wherein textual data comprises one or more of social media data, news headlines, and financial reports.

17. The computer system of claim 15, further comprising:
program instructions to filter the textual data based on topic area.

18. The computer system of claim 15, wherein the one or more selector tools further comprise a selector tool for user-designated merging and splitting of topics.

19. The computer system of claim 15, further comprising:
program instructions to receive a user input controlling a selector tool to alter one or more of the location criteria and time criteria;
program instructions to filter the textual data based on the altered criteria;
program instructions to determine, based on semantic analysis, one or more topics of interest associated with the textual data filtered based on the altered criteria;
program instructions to generate one or more altered user-navigable visualizations; and
program instructions to display the one or more altered user-navigable visualizations.

20. The computer system of claim 15, further comprising:
program instructions to receive a user input controlling a selector tool to merge one or more topics;
program instructions to generate one or more altered user-navigable visualizations based on the user input; and
program instructions to display the one or more altered user-navigable visualizations.
